(19) United States
(12) Patent Application Publication
(10) Pub. No.: US 2020/0133946 A1
(43) Pub. Date: Apr. 30, 2020

(54) METHOD AND APPARATUS FOR SEARCHING FOR SIMILAR PATENT BASED ON ELEMENT ALIGNMENT

(71) Applicant: Electronics and Telecommunications Research Institute, Daejeon (KR)

(72) Inventors: Min Ho KIM, Daejeon (KR); Hyun Ki KIM, Daejeon (KR); Ji Hee RYU, Daejeon (KR); Kyung Man BAE, Daejeon (KR); Yong Jin BAE, Daejeon (KR); Hyung Jik LEE, Daejeon (KR); Soo Jong LIM, Daejeon (KR); Joon Ho LIM, Daejeon (KR); Myung Gil JANG, Daejeon (KR); Mi Ran CHOI, Daejeon (KR); Jeong HEO, Daejeon (KR)

(73) Assignee: Electronics and Telecommunications Research Institute, Daejeon (KR)

(21) Appl. No.: 16/560,792

(22) Filed: Sep. 4, 2019

(30) Foreign Application Priority Data
Oct. 24, 2018 (KR) 10-2018-0127608

(51) Int. Cl. G06F 16/242; G10L 15/22; G10L 15/08; G06F 16/93; G06F 16/903; G06F 16/23; G06Q 50/18

(52) U.S. Cl. CPC G06F 16/2428; G10L 15/22; G10L 15/08; G06F 16/93; G06F 2216/11; G06F 16/2379; G06Q 50/184; G10L 2015/223; G10L 2015/088; G06F 16/90344

(57) ABSTRACT

Provided are a method and apparatus for searching of a similar patent based on element alignment. The method includes: extracting patent elements from an input query patent, extracting search words from the elements, and searching for a similar patent; aligning the elements of the query patent with elements of a similar patent obtained through the search and calculating a matching rate; determining whether any element has been unmatched between the elements of the query patent and the elements of the similar patent and extracting an unmatched element; determining whether an additional search is necessary and causing a user to input a paraphrase suitable to additionally search for the unmatched element when an additional search is necessary; and receiving the paraphrase input by the user, changing the unmatched element for the received paraphrase, and returning to the searching for a similar patent using the changed paraphrase.

### CROSS-REFERENCE TO RELATED APPLICATION

This application claims priority to and the benefit of Korean Patent Application No. 10-2018-0127608, filed on Oct. 24, 2018, the disclosure of which is incorporated herein by reference in its entirety.

### BACKGROUND

### 1. Field of the Invention

The present invention relates to a technology for searching for a patent similar to an input query patent. More particularly, the present invention relates to a method and apparatus for searching for a similar patent on the basis of a natural language in which most content of patents is expressed.

### 2. Discussion of Related Art

Most existing systems for searching for a similar patent are keyword-based search systems. In other words, a search is carried out using a keyword suggested by a user or a keyword automatically extracted by a machine. Also, since most patent specifications are described in natural languages, a natural language analysis technique is used to improve search performance in some cases. For example, morpheme analysis, syntactic analysis techniques, N-gram techniques, etc. are used.

However, it is necessary to solve the following problems because patents have a special description method.

1. Patents are described with structural elements and functional elements. Structural elements and functional elements are indicated by a set of words, for example, a phrase or a clause, rather than an individual word. In existing search methods, words are mainly used as basic units for a search, and thus it is difficult to carry out an accurate search. Therefore, a search technique for effectively handling structural elements or functional elements is necessary.

2. Except drawings, almost all content of patents is described in a natural language. Since natural languages have various expressions, one meaning is expressed in various ways. For example, “The birthday of Admiral Yi Sun-Sin is Apr. 28, 1545” and “Admiral Yi Sun-Sin was born on Apr. 28, 1545” have the same meaning but different words or ways of expression. This is referred to as “paraphrasing”. Since existing search techniques are based on matching of identical words, paraphrasing is not effectively processed. Therefore, a solution for the paraphrase problem is necessary.

3. Since patents relate to latest technology, neologisms are frequently coined. Neologisms are major obstacles to searching for similar patents. Therefore, a technique for effectively processing neologisms is necessary for a similar patent search.

### SUMMARY OF THE INVENTION

The present invention is directed to providing a similar patent search method and apparatus for effectively matching structural elements or functional elements, which are semantic units of patent description, each other and coping with the paraphrase problem and the neologism problem which are caused when patent search is carried out.

According to an aspect of the present invention, there is provided a method of searching for a similar patent on the basis of element alignment, the method including: extracting patent elements from an input query patent, extracting search words for a similar patent search from the extracted elements, and searching for a similar patent; aligning the elements of the query patent with elements of a similar patent obtained through the search and calculating a matching rate of the elements of the similar patent to the elements of the query patent; determining whether any element is unmatched between the elements of the query patent and the elements of the similar patent and extracting an unmatched element; determining whether an additional search is necessary and allowing a user to input a paraphrase suitable to additionally search for the unmatched element when an additional search is necessary; and receiving the paraphrase input by the user, replacing the unmatched element with the received paraphrase, and returning to the searching for a similar patent using the paraphrase used for replacement.

The patent elements may be structural elements or functional elements of the patent.

The allowing the user to input the paraphrase may include outputting a paraphrase input user interface (UI).

The extracting of the search words and the searching for the similar patent may additionally include a search word normalization operation of changing each search word to a representative word between the extracting of the search words and the searching for the similar patent.

The method may additionally include: determining whether a valid additional search has been performed using the paraphrase input in the allowing the user to input the paraphrase and whether matching has been additionally performed on the unmatched element using the paraphrase; and registering the input paraphrase in a paraphrase dictionary when it is determined that a valid additional search has been performed.

The method may additionally include: when new data is inserted into the paraphrase dictionary or a data update occurs in the paraphrase dictionary, updating a normalization dictionary; and when the normalization dictionary is updated, updating a search index database (DB).

The method may additionally include: determining whether a valid additional search has been performed using the paraphrase input in the allowing the user to input the paraphrase and whether matching has been additionally performed on the unmatched element using the paraphrase; and displaying the unmatched element when it is determined that a valid additional search has not been performed and matching has not been additionally performed on the unmatched element.

According to another aspect of the present invention, there is provided an apparatus for searching for a similar patent on the basis of element alignment, the apparatus including: a means configured to be connected to user equipment, receive a query patent input to the user equipment, extract elements of the query patent, extract search words for a similar patent search from the extracted elements, and search for a similar patent; a means configured to align the elements of the query patent with elements of a similar patent obtained through the search and calculate a matching rate of the elements of the similar patent to the elements of the query patent; a means configured to determine whether any element is unmatched between the elements of the query patent and the elements of the similar patent and extract an unmatched element; a means configured to determine whether an additional search is necessary and transmit a paraphrase input UI, which allows a user to input a paraphrase suitable to additionally search for the unmatched element, to the user equipment when an additional search is necessary; and a means configured to receive the paraphrase from the user equipment, replace the unmatched element with the received paraphrase, and cause the means of searching for a similar patent to search for a similar patent using the paraphrase used for replacement.

The apparatus may additionally include a search word normalization means configured to replace the search words with representative words before the means of searching for a similar patent searches for a similar patent.

The apparatus may additionally include a means configured to determine whether a valid additional search has been performed using the received paraphrase and whether matching has been additionally performed on the unmatched element using the paraphrase; and a means configured to register the received paraphrase in a paraphrase dictionary when it is determined that a valid additional search has been performed.

The apparatus may additionally include a means configured to update a normalization dictionary when new data is inserted into the paraphrase dictionary or a data update occurs in the paraphrase dictionary; and a means configured to update a search index DB when the normalization dictionary is updated.

The apparatus may additionally include: a means configured to determine whether a valid additional search has been performed using the received paraphrase and whether matching has been additionally performed on the unmatched element using the received paraphrase; and a means configured to display the unmatched element when it is determined that a valid additional search has not been performed and matching has not been additionally performed on the unmatched element.

The paraphrase input UI may additionally include: an alignment information display section configured to show alignment results; and/or an unmatched element display section configured to show the unmatched element.

The configuration and operation of the present invention will become more apparent from embodiments described below with reference to the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows an example illustrating the meaning of matching;

FIG. 2 shows an example illustrating the meaning of alignment;

FIG. 3 is a flowchart of a method of searching for a similar patent on the basis of structural element alignment according to an exemplary embodiment of the present invention;

FIG. 4 is a flowchart of a method of searching for a similar patent on the basis of functional element alignment according to another exemplary embodiment of the present invention;

FIG. 5 is a flowchart illustrating an expanded process of the process of FIG. 3 or FIG. 4;

FIG. 6A, FIG. 6B and FIG. 6C are flowcharts illustrating an additionally expanded process of the process of FIG. 5;

FIG. 7 shows an example of an alignment information display section;

FIG. 8A and FIG. 8B show another example of an alignment information display section;

FIG. 9 shows an example of a user interface (UI) showing an alignment information display section and an unmatched element display section together; and

FIG. 10 shows an example of the UI of FIG. 9 to which a paraphrase input section is added.

### DETAILED DESCRIPTION OF EXEMPLARY EMBODIMENTS

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete, and will fully convey the scope of the present invention to those of ordinary skill in the art to which the present invention pertains. The present invention is defined only by the claims.

Meanwhile, terms used herein are for the purpose of describing embodiments only and are not intended to limit the present invention. As used herein, the singular forms are intended to include the plural forms as well unless the context clearly indicates otherwise. The terms “comprises” or “comprising” used herein indicate the presence of disclosed elements, steps, operations, and/or devices and do not preclude the presence or addition of one or more other elements, steps, operations, and/or devices.

Hereinafter, exemplary embodiments of the present invention will be described in detail with reference to the accompanying drawings. It should be noted that in giving reference numerals to elements of each drawing, like reference numerals refer to like elements even though the like elements are shown in different drawings. While describing the present invention, detailed descriptions of related well-known configurations or functions are omitted when they are determined to obscure the gist of the present invention.

Before description of a method of searching for a similar patent on the basis of structural or functional element alignment according to an exemplary embodiment of the present invention, the definitions of terms and prior knowledge will be described.

Definitions of Structural Elements and Functional Elements and Extraction Methods Thereof

In the patent description, an element is one of literal units which are used to define a patent. Here, two types of elements, structural elements and functional elements are used as main elements for defining a patent. Structural elements and functional elements are described with reference to the following example.

```
TABLE 1
A data processing device comprising:
  a wireless communication unit configured to receive acceleration data
from a walking sensor device;
  a straight-toed gait sensor configured to determine whether a pedestrian
has a straight-toed gait, by using the acceleration data; and
  a display unit configured to provide information about whether the
pedestrian has a straight-toed gait, to the pedestrian.
```

In the above example, “walking sensor device,” “wireless communication unit,” “straight-toed gait sensor,” “display unit,” and “data processing device” are structural elements. “receive acceleration data,” “by using the acceleration data,” “determine whether a pedestrian has a straight-toed gait,” and “provide information to the pedestrian” are functional elements of the structural elements.

In most cases, it is possible to detect a structural element by extracting a noun phrase composed of consecutively connected nouns. At this time, nouns connected by “of” may be recognized as a nominal connection. For example, “whether there is a straight-toed gait of a pedestrian” may be extracted by using “whether there is a pedestrian straight-toed gait”.

Functional elements may be extracted by dividing text into units of verbs or adjectives. For example, “receive acceleration data” may be extracted on the basis of the verb “receive.” In this case, terms including “regarding (with regard to)” and “for (intended for or to)” are excluded.

Hereinafter, the term “element” is assumed to include a structural element and a functional element.

Alignment

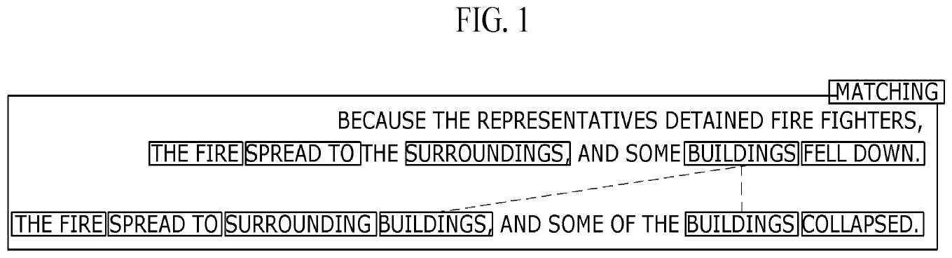

Alignment is to map a specific word, phrase, or clause in one sentence to a word, phrase, or clause in another sentence. Before an example of alignment is shown, the meaning of “matching” is described with the example of FIG. 1. Matching is to determine whether words in one sentence are also present in another sentence. In the example of FIG. 1, it can be seen that “fire,” “surroundings,” “spread,” “buildings,” and “collapse” are all present in both of the first and second sentences. However, in the case of simple vocabulary matching, it is not possible to know whether words matched between the two sentences to reflect the same meaning. For example, in the above example, “buildings” appears two times in the second sentence, but it is not possible to know which “buildings” in the second sentence is indicated by “buildings” in the first sentence.

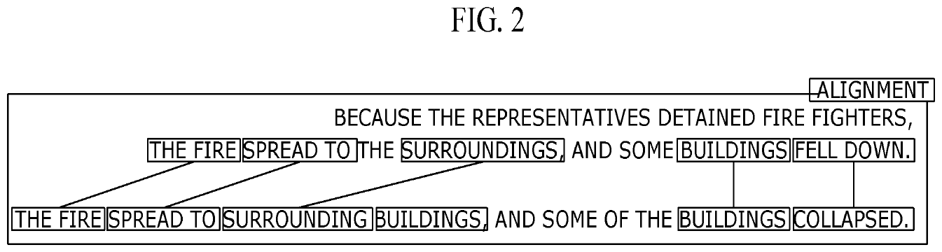

This problem can be solved through “alignment”. As shown in the example of FIG. 2, alignment is to map “buildings” in the first sentence to the latter of two “buildings” in the second sentence. The key to alignment is to use context information. Semantic dependency relationships, semantic role relationships, consecutive word sequence information, neighboring word context information, etc. may be used as context information.

In the example of FIG. 2, as for semantic dependency relationships, “buildings” in the first sentence has a semantic dependency relationship with “collapsed” as a subjective phrase. The former “buildings” in the second sentence has a semantic dependency relationship with “surrounding” as an object. On the other hand, the latter “buildings” has a semantic dependency relationship with “collapsed” as a subject. When “fell down” and “collapsed” are considered to be equivalent as synonyms, the latter “buildings” in the second sentence has the same semantic dependency relationship as the “buildings” in the first sentence. Therefore, the latter “buildings” in the second sentence may be considered to have the same context information as the “buildings” in the first sentence.

As for semantic role relationships, “buildings” in the first sentence and the latter “buildings” in the second sentence have an “object (ARG1)” relationship, which is an equivalent semantic role, with the predicative “fell down (collapsed)” (Here, ARG1 is a symbol indicating an object used in technical standards for semantic role labeling). On the other hand, the former “buildings” in the second sentence has a different semantic role than “buildings” in the first sentence.

As for consecutive word sequence information, “spread and buildings fell down” in the first sentence is mapped to “spread and buildings collapsed” in the second sentence.

As for neighboring word context information, the neighboring context of “buildings” in the first sentence includes “spread” and “fell down.” In the second sentence, the neighboring context of the former “buildings” includes “surroundings” and “spread,” and that of the latter “buildings” includes “spread” and “collapsed (equivalent to “fell down”).” Stronger neighboring word context information distinguishes between front and back. For example, in the first sentence, “spread” is in front of “buildings,” and “fell down” is behind “buildings.”

As described above, alignment of structural elements is to perform an alignment in units of structural elements in a manner similar to that described in the above example.

Paraphrase

A paraphrase is a word, phrase, or clause which has the same meaning as the original but is expressed in a different way. In an exemplary table below, a replacement of “crackdown” for “control” and a replacement of “blame on” for “cause” may be paraphrasing.

TABLE 2
(Sentence 1) The Opium War is an invasion blamed on the crackdown
on opium.
(Sentence 2) The Opium War is an aggressive war of England caused by
the Qing government's control over opium.

Description of Basic Configuration

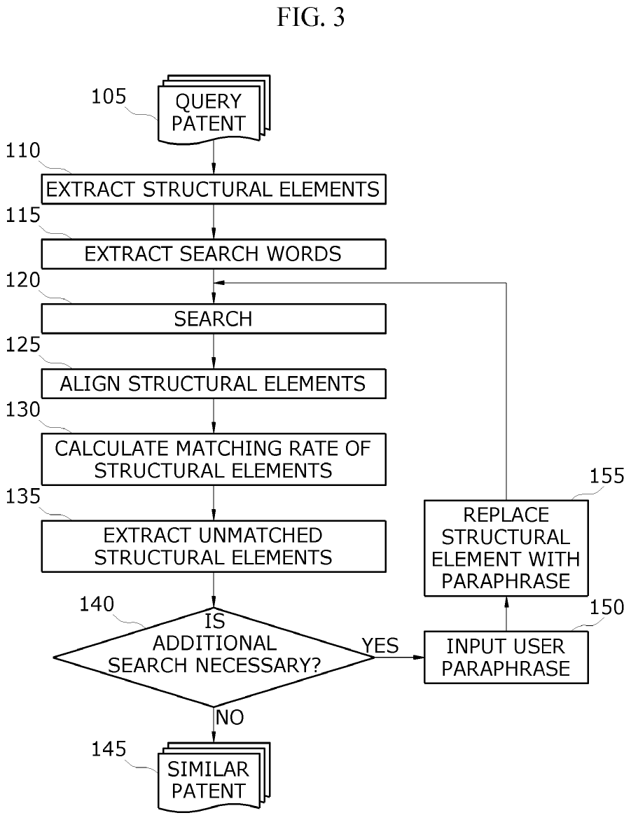

FIG. 3 is a flowchart of a method of searching for a similar patent on the basis of structural element alignment according to an exemplary embodiment of the present invention. Although an exemplary embodiment of the present invention is described with a flowchart of a process in this specification, an apparatus for implementing the spirit of the present invention may be readily embodied from the flowchart. For example, the method according to an exemplary embodiment of the present invention may be implemented in the form of software in a server which communicates with user equipment.

105: Input a query patent—A query patent may be input in the form of a document file such as eXtensible Markup Language (XML) (the document may be in a structuralized file format or not). Alternatively, a query patent may be input through a user interface (UI) by which it is possible to directly input text included in Title, Summary, Claims, etc. that are major items of patent documents. When a query patent is input as text, the query patent may be divided into individual items and input. According to a query patent input method, a user may execute a dedicated application program provided by a server and input a query patent, and a query patent file may be transmitted to the server. The server receives the query patent and performs the following operations.

110: Extract structural elements—The server extracts structural elements which are major patent description units from the input query patent (e.g., the specification or claims of the query patent). Structural elements may be extracted using specific terms (unit, part, section, means, step, etc.) used to draft the patent specification or claims along with delimiters, such as punctuation marks (“;”, “,”, etc.), line breaks, indents, outdents, etc.

115: Extract search words—The server extracts search words from the extracted structural elements. The search words are intended to find a patent similar to the query patent and may be extracted using an existing search word extraction technique (e.g., term frequency-inverse document frequency (TF-IDF)). For example, when the structural element “wireless communication unit” is extracted, the search words “wireless” and “communication” may be extracted from the structural element.

120: Search—The server searches for a similar patent using the extracted search words.

125: Alignment of structural elements—The server aligns the structural elements of the query patent with structural elements of a similar patent (earlier patent application) obtained as a search result. To this end, it is necessary to perform an operation of extracting the structural elements of the similar patent in advance. Structural elements of similar patents may be extracted according to a corresponding similar patent every time similar patents are searched for, or structural elements of all available earlier patent applications may in advance be extracted and stored as a database (DB). In the latter case, the amount of data becomes vast, but it is better in terms of search efficiency.

130: Calculate a structural element matching rate—The server calculates a matching rate (e.g., an alignment score) of the structural elements of the similar patent to the structural elements of the query patent. The matching rate indicates how many structural elements of the query patent are covered by each individual similar patent (e.g., structural elements of similar patent A match five of 10 structural elements extracted from the query patent, and structural elements of similar patent B match seven of the 10 structural elements), or how many structural elements of the query patent are covered by all similar patents rather than each individual similar patent (e.g., structural elements of similar patents A and B match seven of 10 structural elements extracted from the query patent). At this time, similar patents whose matching rates are calculated may be limited to those having a structural element matching rate of a certain level or higher with respect to the query patent.

135: Extract unmatched structural elements: The server determines whether there is an unmatched structural element between the structural elements of the query patent and the structural elements of the similar patent and extracts unmatched structural elements.

140: Determine whether an additional search is necessary on the basis of the calculated matching rate and the unmatched structural elements—The server determines whether an additional search is necessary on the basis of the structural element matching rate and the unmatched structural elements. For example, it is possible to determine that an additional search is necessary when the matching rate is smaller than or equal to a predetermined threshold value or the importance of an unmatched structural element is greater than or equal to a predetermined threshold value. Alternatively, when the matching rate is smaller than or equal to the predetermined threshold value and the importance of an unmatched structural element is greater than or equal to the predetermined threshold value, it is possible to determine that an additional search is necessary. The importance of an unmatched structural element may be calculated using TF-IDF or the like. In this way, it is possible to determine whether an additional search is necessary using a matching rate and unmatched structural elements.

145: Output the similar patent as a search result—The server outputs the retrieved similar patent(s) as a search result when it is determined in operation 140 that an additional search is not necessary (in the case of “NO”). The user equipment may be provided with the result output from the server.

150: Input a user paraphrase for an unmatched structural element—The server allows a user to input a paraphrase suitable to additionally search for an unmatched structural element when it is determined in operation 140 that an additional search is necessary (in the case of “YES”). To this end, a paraphrase input UI may be provided in the user equipment. In addition to a paraphrase input section, the UI may include an unmatched structural element display section and/or an alignment display section (will be described below).

155: Replace a structural element with a paraphrase—When a paraphrase is input from the user equipment, the server receives the paraphrase and replaces the unmatched structural element with the input paraphrase and performs operation 120 and the subsequent processes again using the paraphrase used for replacement.

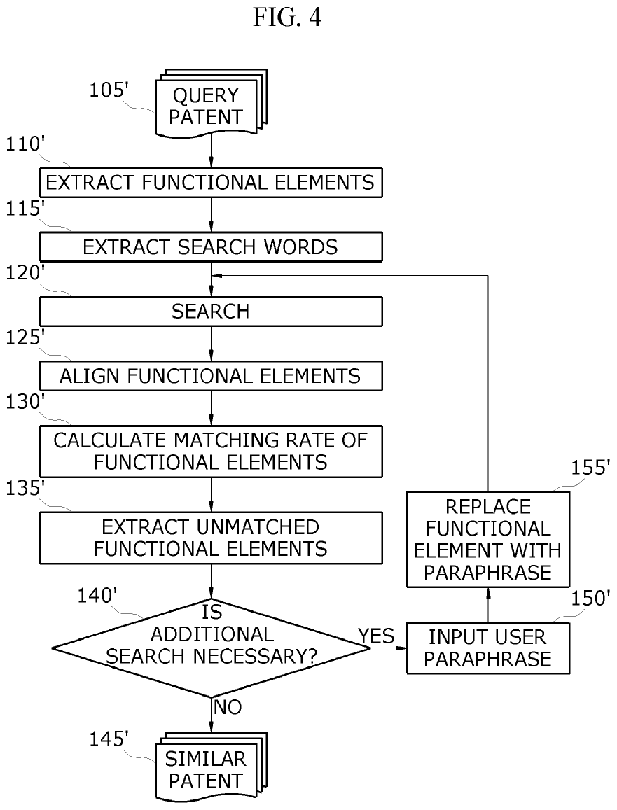

Although structural elements are used as objects of a search and objects of matching in the basic configuration of an exemplary embodiment, functional elements rather than structural elements may be used to perform the process. FIG. 4 illustrates this case. When functional elements are used as objects of a search and objects of matching, a process may be generally performed as follows:

105′: Input a query patent

110′: Extract functional elements—The server extracts functional elements which are major patent description units from an input query patent. As mentioned above, functional elements may be extracted by dividing text into units of verbs or adjectives. For example, “receive acceleration data” may be extracted on the basis of the verb “receive.”

115′: Extract search words—The server extracts search words from the extracted functional elements.

120′: Search—The server searches for a similar patent using the extracted search words.

125′: Alignment of functional elements—The server aligns the functional elements of the query patent with functional elements of a similar patent (earlier patent application) obtained as a search result. To this end, it is necessary to perform an operation of extracting the functional elements of the similar patent in advance.

130′: Calculate a functional element matching rate—The server calculates a matching rate (e.g., an alignment score) of the functional elements of the similar patent to the functional elements of the query patent.

135′: Extract unmatched functional elements: The server determines whether a functional element is unmatched and extracts unmatched functional elements from the query patent.

140′: Determine whether an additional search is necessary on the basis of the calculated matching rate and the unmatched functional elements—The server determines whether an additional search is necessary on the basis of the functional element matching rate and the unmatched functional elements.

145′: Output the similar patent as a search result—The server outputs the similar patent as a search result when it is determined in operation 140′ that an additional search is not necessary (in the case of “NO”).

150′: Input a user paraphrase for an unmatched functional element—The server allows a user to input a paraphrase suitable to additionally search for an unmatched functional element when it is determined in operation 140′ that an additional search is necessary (in the case of “YES”). To this end, a paraphrase input UI may be provided to the user.

155′: Replace a functional element with a paraphrase—When the user inputs a paraphrase for the unmatched functional element, the server replaces the unmatched functional element with the input paraphrase and performs operation 120′ and the subsequent processes again using the paraphrase used for replacement.

Description of Expanded Configuration

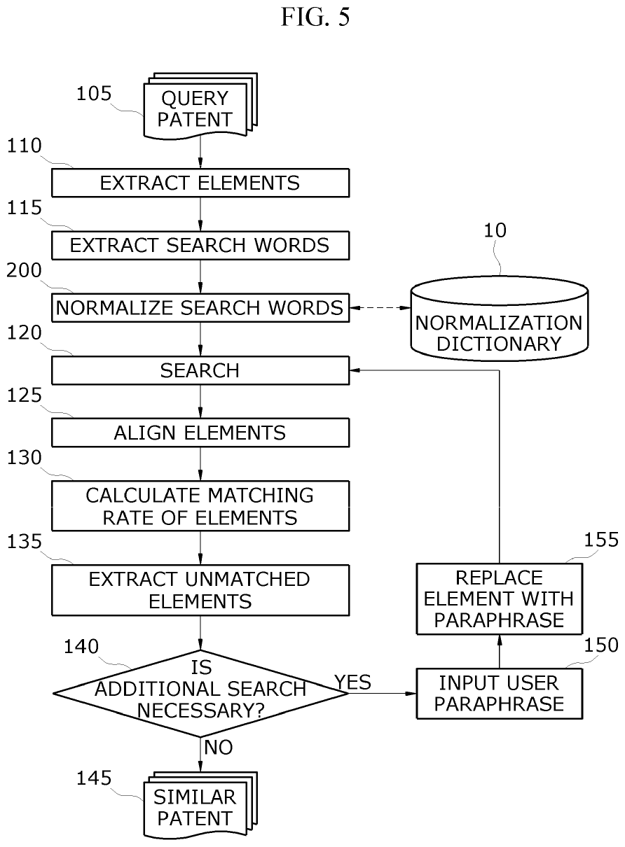

An expanded configuration which is obtained by adding another means to the basic configuration of FIG. 3 or 4 will be described. The expanded configuration of FIG. 5 is obtained by adding search word normalization to the basic configuration of FIG. 3 or 4. This is intended to improve search performance. As mentioned above, the term “element” used in FIG. 5 includes a structural element and a functional element.[076] 200: Search word normalization—A search word normalization process 200 may be added between search word extraction 115 and search 120. After this process, a normalized search word is used to perform a search. Search word normalization is described as follows. Search word normalization means changing each search word, which will be used in a search, to a representative word.

TABLE 3
(Query sentence) The Opium War is an invasion blamed on the crackdown
on opium.
(Sentence included in search DB) The Opium War is an aggressive war of
England caused by the Qing government's control over opium.

In the exemplary table above, “crackdown” and “blame” included in the query sentence are not included in a corresponding sentence in a search DB and thus are likely not to be retrieved. In other words, a search response rate may be lowered. When “crackdown” and “blame” included in the query sentence are respectively changed to “control” and “cause” included in a sentence in the search DB, it is possible to obtain a search response. Conversely, when “control” and “cause” are respectively changed to “crackdown” and “blame,” it is also possible to obtain a search result. However, the search DB has already been built, and thus it is not possible to change sentences in the search DB. This problem can be solved by normalization. As shown in Table 4 below, a normalization dictionary DB 10 is built by normalizing a certain word constituting a sentence to a representative word among similar words. When a query is input, a new query sentence is obtained by changing a word to an existing representative word, and the new query sentence is used for search.

TABLE 4

| Representative word | Set of similar words |
|---|---|
| Control | Crackdown, supervision, regulation, control |
| Cause | Blame, pretext, reason, trigger, cause |

Therefore, the query sentence “the Opium War is an invasion blamed on the crackdown on opium” is changed for the sentence “the Opium War is an aggressive war caused by control over opium” including normalized search words, and it is possible to search for the sentence “the Opium War is an aggressive war of England caused by Qing government's control over opium” stored in the search DB.

Description of Additionally Expanded Configuration

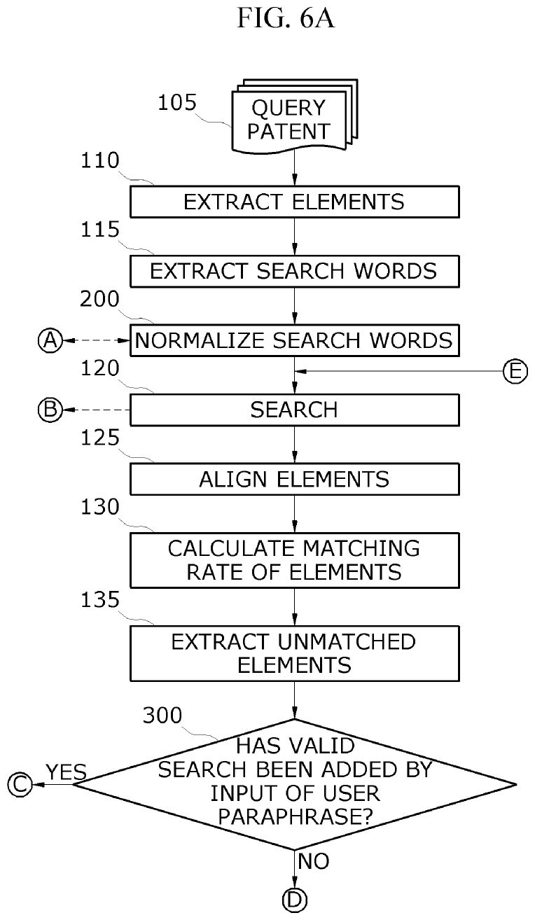

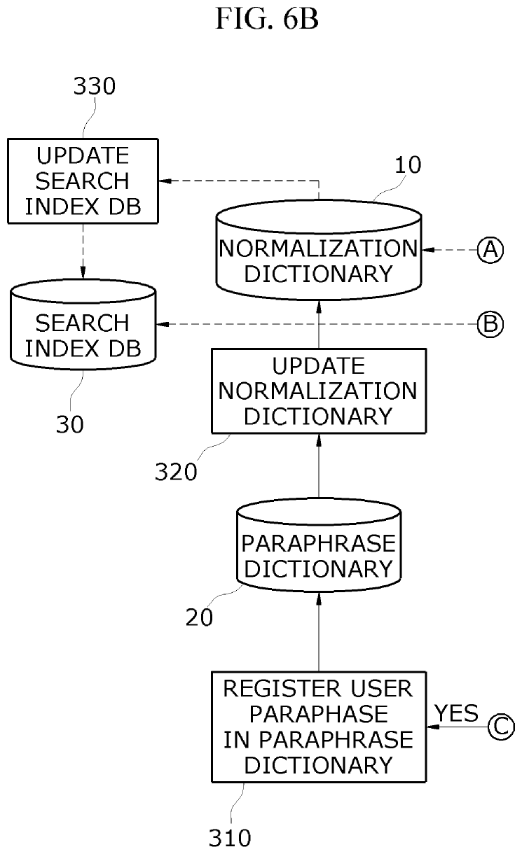

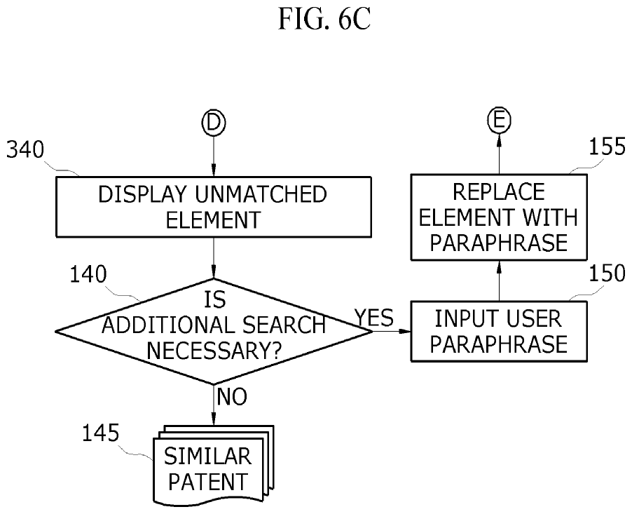

FIG. 6A, FIG. 6B and FIG. 6C are obtained by adding a means for enhancing knowledge and information through user interaction to the configuration of FIG. 5. This is also intended to improve search performance. As mentioned above, the term “element” used in FIG. 6A and FIG. 6C includes a structural element and a functional element.

300: Determine whether a valid search result has been added by an input of a user paraphrase—The server determines whether a valid similar patent has been retrieved and added by an input of a user paraphrase in operation 150 and additional matching has been performed for an unmatched element (a structural element or a functional element; the same as above).

310: Register the user paraphrase in a paraphrase dictionary 20 when the determination of operation 300 is “YES”—The server registers the paraphrase input by the user in the paraphrase dictionary 20 when a valid additional search has been performed.

Operations 300 and 310 are not limited to those illustrated in FIG. 6A and FIG. 6B and may be at any one position between the element matching rate calculating operation 130 and the similar patent output operation 145.

320: Update a normalization dictionary—The server updates a normalization dictionary 10 periodically or every time new data is added to the paraphrase dictionary 20 or data is updated in the paraphrase dictionary 20.

330: Update a search index DB—The server updates a search index DB 30 periodically or every time the normalization dictionary 10 is updated in operation 320. Accordingly, the updated search index DB 30 may be used to perform a search in operation 120.

340: Meanwhile, when the determination of operation 300 is “NO,” that is, when a valid similar patent has not been retrieved by the input of the user paraphrase in operation 150 and additional matching has not been performed for an unmatched element, the server displays the unmatched element. The unmatched element may be displayed together with alignment information. In this way, the user may conveniently understand matching results of a query patent. This operation is not limited to the position shown in FIG. 5 and may be at any position between the unmatched element extracting operation 135 and operation 140 of determining whether an additional search is necessary.

As mentioned above in operation 150 of FIG. 3, the UI for displaying unmatched elements is an unmatched element display section which may be included in a paraphrase input UI for allowing a user to input a paraphrase. Although the unmatched element display section may be displayed alone, it may be designed to be displayed together with an alignment information display section for user convenience. Like this, when a UI relating to element alignment results is provided in user equipment, it is possible to help a user to input a user paraphrase for an unmatched element. Also, the user may be presented a basis when a user determines whether an additional search is necessary according to a matching rate and an unmatched element.

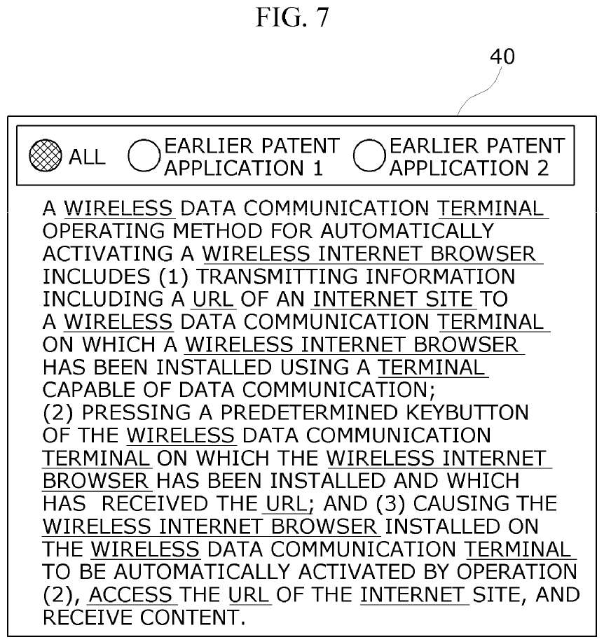

FIG. 7 shows results of element alignment of a query patent with retrieved similar patents as an example of an alignment information display section 40. The alignment information display section 40 of FIG. 7 displays text of the query patent and shows how many elements of the query patent match all the similar patents. In FIG. 7, underlined words are elements aligned with all the similar patents. Meanwhile, according to each similar patent, aligned elements may be displayed only when an alignment rate with the similar patent is greater than or equal to a value predefined by a user.

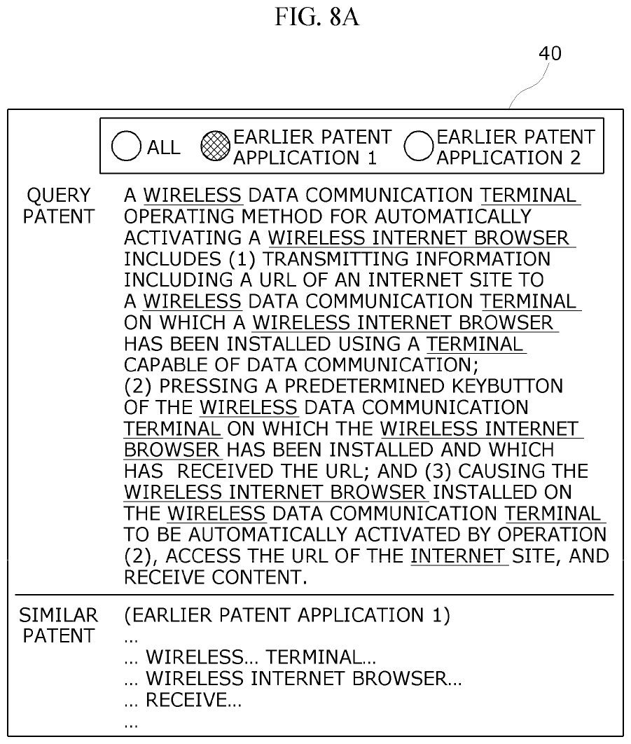

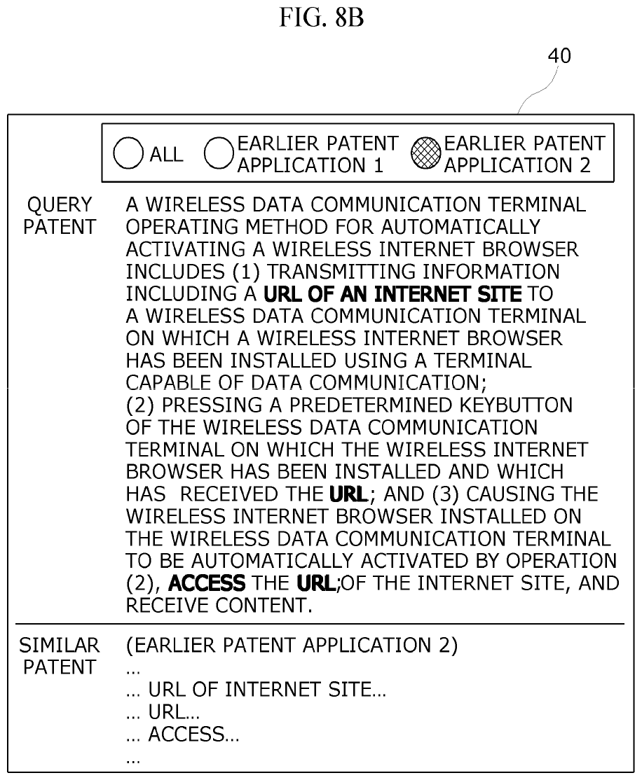

FIGS. 8A and 8B show elements aligned with each specific similar patent rather than all similar patents as another example of the alignment information display section 40. In other words, elements aligned with earlier patent application 1 are underlined in FIG. 8A, and elements aligned with earlier patent application 2 are marked in bold in FIG. 8B. Also, in the lower part of FIGS. 8A and 8B, elements aligned with the similar patents are directly displayed in text.

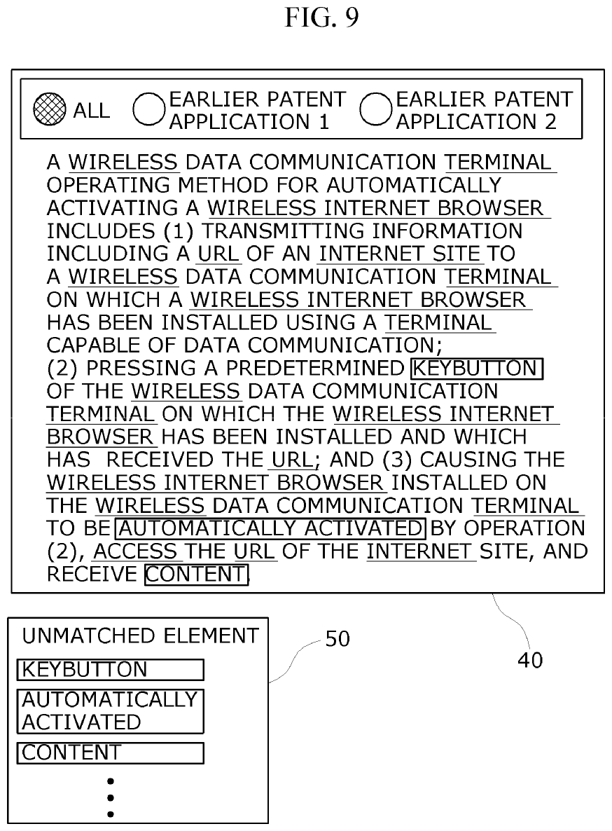

FIG. 9 shows an example of a UI showing an unmatched element display section 50 for displaying elements unmatched in alignment together with the alignment information display section 40. In the text of a query patent, alignment information is underlined, and unmatched elements are boxed. Aside from this, unmatched elements are listed in text in the below.

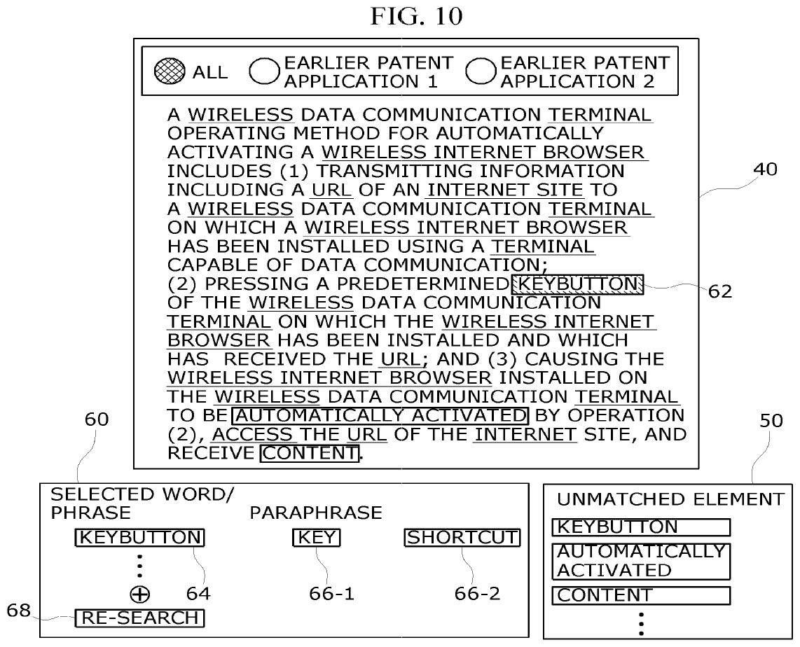

FIG. 10 shows an example of the UI of FIG. 9 to which a paraphrase input section 60 for allowing a user to input paraphrases for unmatched elements is added.

A user may select a desired unmatched element area (hatched box) 62. An expression (a word, phrase, or clause) in the selected area is displayed in a selected element display window 64, and the user may input a desired paraphrase for the expression in one or more paraphrase input windows 66-1 and 66-2. When a re-search button 68 is pressed, a re-search is performed by additionally using the input user paraphrase. It is possible to provide similar patent search results to the user again by merging re-search results with previous results.

The present invention can be implemented in terms of apparatus or method. In particular, a function or process of each structural element of the present invention can be implemented by a hardware element including at least one of a digital signal processor (DSP), a processor, a controller, an application-specific integrated circuit (ASIC), a field programmable gate array (FPGA), and other electronic devices or a combination thereof. A function or process of each structural element can also be implemented in software in combination with or separately from a hardware element, and the software can be stored in a recording medium.

According to exemplary embodiments of the present invention, it is possible to effectively align structural elements or functional elements, which are semantic units of patent description, of a query patent and a retrieved patent. It is possible to extract structural elements or functional elements and compare common functions between the two patents through structural element or functional element alignment.

Also, it is possible to mitigate the neologism problem which has always been a problem in a similar patent search system and the problem of unsearchableness resulting from the paraphrase problem caused by the diversity of expressions in patent drafting.

It is possible to acquire new patent paraphrase knowledge on the basis of search validity of an input paraphrase. Also, search word normalization knowledge can be enhanced by updating a normalization dictionary on the basis of new paraphrase knowledge.

The present invention has been described in detail above with reference to exemplary embodiments. Those of ordinary skill in the technical field to which the present invention pertains should understand that various modifications and alterations can be made without departing from the spirit and scope of the present invention. Therefore, it should be understood that the disclosed embodiments are not limiting but illustrative. The scope of the present invention is defined not by the specification but by the following claims, and it should be understood that the present invention encompasses all differences within the equivalents thereof.

What is claimed is:

1. A method of searching for a patent similar to a query patent on the basis of element alignment, the method comprising:
extracting element from an input query patent, extracting search word for a similar patent search from the extracted element, and searching for a similar patent;
aligning the element of the query patent with element of a similar patent obtained through the search and calculating a matching rate of the element of the similar patent to the element of the query patent;
determining whether any element is unmatched between the element of the query patent and the element of the similar patent and extracting an unmatched element;
determining whether an additional search is necessary and allowing a user to input a paraphrase suitable to additionally search for the unmatched element when an additional search is necessary; and
receiving the paraphrase input by the user, replacing the unmatched element with the received paraphrase, and returning to the searching for a similar patent using the paraphrase used for replacement.

2. The method of claim 1, wherein the element is selected from a group of structural element and functional element of a patent.

3. The method of claim 1, wherein the aligning the element of the query patent with the element of the similar patent comprises extracting element from the retrieved similar patent.

4. The method of claim 1, wherein the calculating of the matching rate comprises calculating the number of element of each similar patent matching the element of the query patent.

5. The method of claim 1, wherein the calculating of the matching rate comprises calculating the number of element of all similar patents matching the element of the query patent.

6. The method of claim 1, wherein the calculating of the matching rate is performed on a similar patent having an element matching rate of a predetermined level or higher with respect to the query patent.

7. The method of claim 1, wherein the determining of whether an additional search is necessary is performed using the element matching rate and unmatched elements.

8. The method of claim 1, wherein the allowing the user to input the paraphrase comprising outputting a paraphrase input user interface (UI).

9. The method of claim 1, wherein the extracting of the search word and the searching for the similar patent additionally comprises a search word normalization operation of changing search word to a representative word between the extracting of the search word and the searching for the similar patent.

10. The method of claim 9, further comprising:
determining whether a valid additional search has been performed using the paraphrase input in the allowing the user to input the paraphrase and whether matching has been additionally performed on the unmatched element using the paraphrase; and
registering the input paraphrase in a paraphrase dictionary when it is determined that a valid additional search has been performed.

11. The method of claim 10, further comprising:
updating a normalization dictionary when new data is inserted into the paraphrase dictionary or a data update occurs in the paraphrase dictionary; and
updating a search index database (DB) when the normalization dictionary is updated.

12. The method of claim 9, further comprising:
determining whether a valid additional search has been performed using the paraphrase input in the allowing the user to input the paraphrase and whether matching has been additionally performed on the unmatched element using the paraphrase; and
displaying the unmatched element when it is determined that a valid additional search has not been performed and matching has not been additionally performed on the unmatched element.

13. An apparatus for searching for a similar patent on the basis of element alignment, the apparatus comprising:
a means configured to be connected to a user equipment, receive a query patent input to the user equipment, extract element of the query patent, extract search word for a similar patent search from the extracted element, and search for a similar patent;
a means configured to align the element of the query patent with element of a similar patent obtained through the search and calculate a matching rate of the element of the similar patent to the elements of the query patent;
a means configured to determine whether element is unmatched between the element of the query patent and the element of the similar patent and extract an unmatched element;
a means configured to determine whether an additional search is necessary and transmit a paraphrase input user interface (UI), which allows a user to input a paraphrase suitable to additionally search for the unmatched element, to the user equipment when an additional search is necessary; and
a means configured to receive the paraphrase from the user equipment, replace the unmatched element with the received paraphrase, and cause the means of searching for a similar patent to search for a similar patent using the paraphrase used for replacement.

14. The apparatus of claim 13, wherein the element is selected from a group of structural element and functional element of a patent.

15. The apparatus of claim 13, further comprising a search word normalization means configured to change the search word to representative word before the means of searching for a similar patent searches for a similar patent.

16. The apparatus of claim 13, further comprising:
a means configured to determine whether a valid additional search has been performed using the received paraphrase and whether matching has been additionally performed on the unmatched element using the paraphrase; and
a means configured to register the received paraphrase in a paraphrase dictionary when it is determined that a valid additional search has been performed.

17. The apparatus of claim 14, further comprising:
a means configured to update a normalization dictionary when new data is inserted into the paraphrase dictionary or a data update occurs in the paraphrase dictionary; and
a means configured to update a search index database (DB) when the normalization dictionary is updated.

18. The apparatus of claim 13, further comprising:
a means configured to determine whether a valid additional search has been performed using the received paraphrase and whether matching has been additionally performed on the unmatched element using the received paraphrase; and
a means configured to display the unmatched element when it is determined that a valid additional search has not been performed and matching has not been additionally performed on the unmatched element.

19. The apparatus of claim 13, wherein the paraphrase input UI further comprises an alignment information display section configured to show alignment results.

20. The apparatus of claim 13, wherein the paraphrase input UI further comprises an unmatched element display section configured to show the unmatched element.
